(19) United States
(12) Patent Application Publication
(10) Pub. No.: US 2016/0279745 A1
(43) Pub. Date: Sep. 29, 2016

(54) Installation Equipment and Assembling and Disassembling Method Thereof

(71) Applicant: Self Electronics Co., Ltd., Ningbo (CN)

(72) Inventors: Chengke Zhang, Ningbo (CN); Zhaoyong Zheng, Ningbo (CN)

(73) Assignees: Wanjiong Lin, Ningbo (CN); Self Electronics USA Corporation, Norcross (CN)

(21) Appl. No.: 15/080,175

(22) Filed: Mar. 24, 2016

(30) Foreign Application Priority Data
Mar. 25, 2015 (CN) 201510131941.3

(51) Int. Cl. B23P 11/00

(52) U.S. Cl. CPC B23P 11/00

(57) ABSTRACT

An installation equipment includes a holder and an installing board. The holder includes a connecting board, a first installing wall perpendicular to the connecting board, two second installing walls perpendicular to the connecting board and located on two sides of the first installing wall respectively, at least one lock disposed on the first installing wall, at least one locating column perpendicularly extending from the connecting board, and at least two protrusions disposed on the two second installing wall respectively. The installing board is disposed in the holder and includes at least one locating hole, the installing board being clamped among the lock and the two protrusions and the connecting board. The installing board is fixed into the holder so that the installed device connected to the installing board can be fixed onto the holder. The invention further includes an assembling and disassembling method of the installation equipment.

### RELATED APPLICATION

This present application claims benefit of the Chinese Application, CN201510131941.3, filed on Mar. 25, 2015.

### BACKGROUND

1. Technical Field

The present application relates to lighting devices, and more particularly to an installation equipment and assembling and disassembling method thereof.

2. Description of the Related Art

Lamps are a very common device in our daily life, such as roadside lamp, factory lighting, and household lighting device. Owing to different locations and purposes, lamps have various kinds of shapes, colors and fixings. However, it is impossible for indicating every problem of lamps and the present invention is focused on the length adjustable structure for upright lamp.

To meet the need of each purpose for use, lamps are designed into fixed, movable or semi-movable types. In the prior art, the device for installing or fixing is complicated high-cost, and low universality. Moreover, the assembling method of the device usually adopts fasteners to fix the lamp, such as screw, double-screw bolt, and so on. However, it is difficult to disassemble the device so that the lamp is limited in some specific application fields.

Therefore, it is necessary to provide a installation equipment and assembling and disassembling method thereof to solve the above problem.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is an isometric view of an installation equipment according to a embodiment.

FIG. 2 is an isometric and explosive view of the installation equipment of FIG. 1

FIG. 3 is an isometric view of a holder of the installation equipment of FIG. 1.

FIG. 4 is a flow chart of an assembling method of the installation equipment of FIG. 1.

FIG. 5 is a flow chart of a disassembling method of the installation equipment of FIG. 1.

### DETAILED DESCRIPTION

The present application is illustrated by way of example and not by way of limitation in the figures of the accompanying drawings. It should be noted that references to “an” or “one” embodiment in this disclosure are not necessarily to the same embodiment, and such references mean at least one.

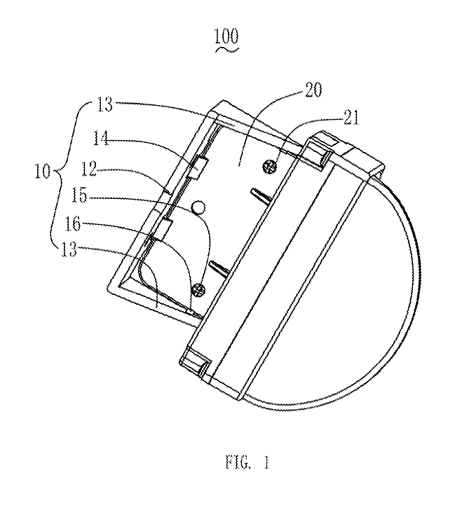

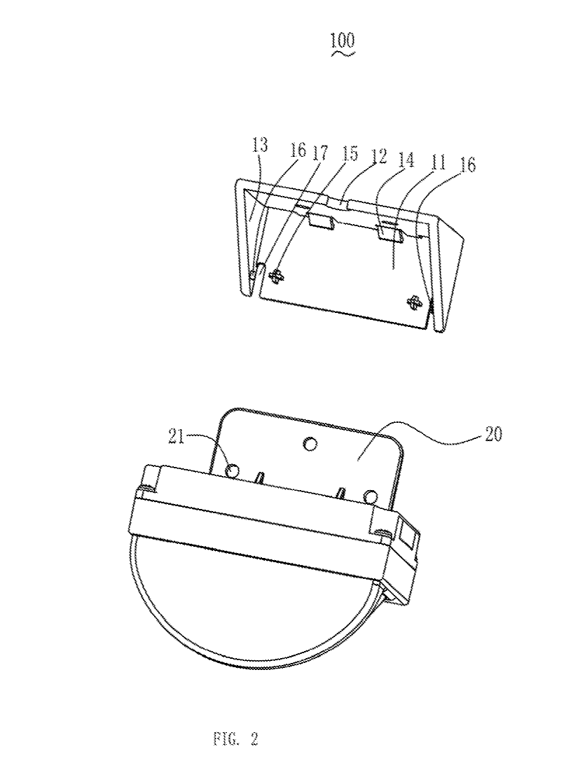

Referring to FIG. 1 and FIG. 2, an installation equipment 100 is shown according to an embodiment. The installation equipment 100 includes a holder 10, and an installing board 20 disposed in the holder 10. It may be understood that the installation equipment 100 may includes other function module, such as induction module, lighting module, and so on which is mounted on the installing board 20.

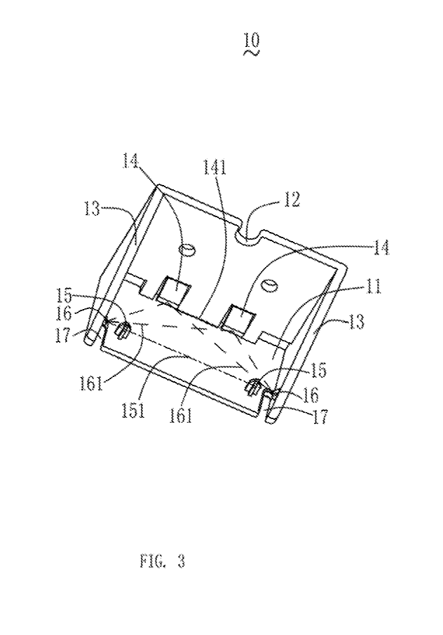

Referring to FIG. 3 together, the holder 10 is configured for being fixed on the application area. For example, the holder 10 may be fixed on the wall or desktop by some way of clamping, inserting, and so on. In the present embodiment, the holder 10 is fixed on the wall via two screws. The holder 10 includes a connecting board 11, a first installing wall 12 perpendicular to the connecting board 11, two second installing walls 13 perpendicular to the connecting board 11 and located on two sides of the first installing wall 12, at least one lock 14 disposed on the first installing wall 12, at least one locating column 15 perpendicularly extending from the connecting board 11, and at least two protrusions 16 disposed on the two second installing walls 13 respectively.

The connecting board 11 is configured for assembling the installing board 20 onto the holder 10 together with the lock 14 and the two protrusions 16. The connecting board 11 may have random shape as long as the installing board 20 does not come off the holder 10. In the present embodiment, the connecting board 11 has a similar shape with the installing board 20.

The first installing wall 12 is disposed on the periphery of the connecting board 11 and is made of plastics. The first installing wall 12 is configured to fix the holder 10 to the application area and dispose the lock 14. The two second installing walls 13 are disposed two sides of the first installing wall 12 and also locate on the periphery of the connecting board 11 so as that the ligatures 161 between the lock 14 and the two protrusions 16 form a triangle. As shown in FIG. 3, the ligatures 161 between the lock 14 and the two protrusions 16 are shown in dashed line. It may be understood that the ligatures 161 may form two triangles. The first installing wall 12 and the two second installing walls 13 enclose the connecting board 11. The lock 14 has a free end, and the free end of the lock 14 tilts towards the installing board 20. In the present embodiment, two locks 14 are disposed on the first installing wall 12. The lock 14 is integrated with first installing wall 12 and a ligature 141 between the two locks 14 is parallel to the connecting board 11 so as that the two locks 14 can press against the installing board 20 at the same time. As shown in FIG. 3, the ligature 141 between the two locks 14 is shown in dot line. At least two protrusions 16 are respectively disposed on the two second installing wall 13. It may be understood that when the two protrusions 16 have not been pressed and are in the raw, the distance therebetween is less than or equal to the width of the installing board 20. Each of the two protrusions 16 may have a convex protrusion shape, or a mortar shape, and so on. It may be understood that the distance of the two protrusions 16 may increase or decrease when it is pressed in a permitted range of tolerance so as to assemble or disassemble the installing board 20. Since the plane, which is formed by the triangle of the ligature 161 between the lock 14 and the two protrusions 16, may have an angle less than 90 degree with the connecting board 11. In the present embodiment, the plane formed via the triangle is parallel to the connecting board 11. Moreover, a minimum distance between the lock 14 or the protrusions 16 and the connecting board 11 is equal to the thickness of the installing board 20 so as to clamping the installing board 20 therebetween and limiting the installing board 20 in vertical direction perpendicular to the installing board 20.

The at least one locating column 15 is arranged onto the connecting board 11 and configured for limiting the installing board 20 in horizon direction parallel to the installing board 20. In the present embodiment, the holder 10 includes two locating columns 15. The ligature 151 of the two locating columns 15 is parallel to the connecting board 11. As shown in FIG. 3, the ligature 151 is shown in dot dash line. The configuration and work principle of the locating column 15 will be described in detail as follow.

The holder 10 further includes two U-typed gaps 17. The two U-typed gaps 17 are opened between the two second installing wall 13 and the connecting board 11 respectively. The two U-typed gaps 17 are configured for changing the distance between the two protrude 16 when it is pressed so as to same labor.

The installing board 20 is mounted in the holder 10 and includes at least one locating hole 21. When the installing board 20 is clamped among the lock 14 and the two protrusions 16 and the connecting board 11, the locating column 15 is inserted through the locating hole 21. In the present embodiment, as the holder 10 includes two locating columns 15 the installing board 20 has two locating holes 21 correspondingly. The locating column 15 may have random shape, such as cylinder, cross-shaped, and so on. The locating hole 21 may have uniform shape with the locating column 15 or a circular hole which can contain anyone of the locating column 15.

As described above, the installing board 20 is clamped among the lock 14 and the two protrusions 16 and the connecting board 11 so as to limit it in vertical direction perpendicular to the connecting board 11. Moreover, the locating column 15 is inserted through the locating hole 21 in order to limit the installing board 20 in horizon direction parallel to the connecting board 11. As a result, the installing board 20 is fixed into the holder 10 so that the installed device connected to the installing board 20 can be fixed onto the holder 10. Therefore, the installing equipment 100 is simple and is ease to assemble, and so, it will same time and is cost down.

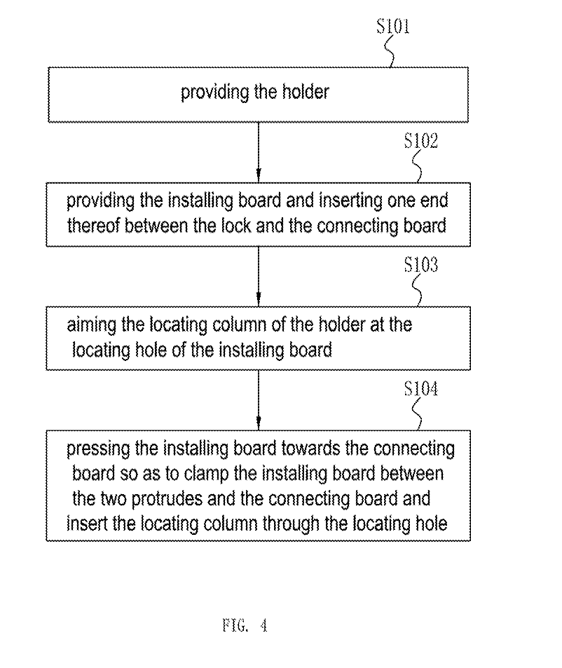

Referring to FIG. 4, a flow chart of an assembling method of the installing equipment 100 is shown. The assembling method of the installing equipment 100 includes the following steps:

S101: providing the holder 10;

S102: providing the installing board 20 and inserting one end thereof between the lock 14 and the connecting board 11;

S103: aiming the locating column 15 of the holder 10 at the locating hole 21 of the installing board 20; and

S104: pressing the installing board 20 towards the connecting board 11 so as to clamp the installing board 11 between the two protrusions 16 and the connecting board 11 and insert the locating column 15 through the locating hole 21.

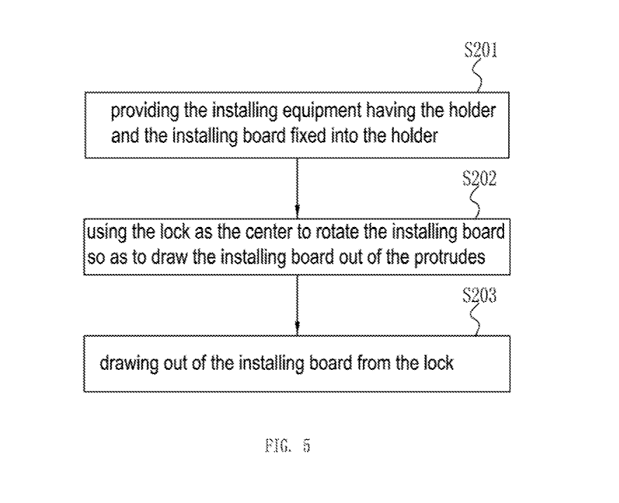

Referring to FIG. 5, a flow chart of a disassembling method of the installing equipment 100 is shown. The disassembling method of the installing equipment 100 includes the following steps:

S201: providing the installing equipment 100 having the holder 10 and the installing board 20 fixed into the holder 10;

S202: using the lock 14 as the center to rotate the installing board so as to draw the installing board 20 out of the protrusions; and

S203: drawing out of the installing board from the lock 14.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An installation equipment, comprising:
a holder comprising a connecting board, a first installing wall perpendicular to the connecting board, two second installing walls perpendicular to the connecting board and located on two sides of the first installing wall respectively, at least one lock disposed on the first installing wall, at least one locating column perpendicularly extending from the connecting board, and at least two protrusions disposed on the two second installing wall respectively, the first and second installing walls being on the periphery of the connecting board so as that ligatures between the lock and two protrusions form a triangle; and
an installing board disposed in the holder and comprising at least one locating hole, the installing board being clamped among the lock and the two protrusions and the connecting board, the locating column being inserted through the locating hole.

2. The installation equipment as claimed in claim 1, wherein a plane formed via the triangle is parallel to the connecting board.

3. The installation equipment as claimed in claim 1, wherein a minimum distance between the lock or the protrusions and the connecting board is equal to the thickness of the installing board.

4. The installation equipment as claimed in claim 1, wherein the holder comprises two locks, a ligature between the two locks is parallel to the connecting board.

5. The installation equipment as claimed in claim 1, wherein the holder further comprises two U-typed gaps between the second installing wall and the connecting board.

6. The installation equipment as claimed in claim 1, wherein the free end of the lock tilts towards the installing board.

7. The assembling method of the installation equipment as claimed in claims from claim 1 to claim 6, the assembling method comprising the following steps:
providing the holder;
providing the installing board and inserting one end thereof between the lock and the connecting board;
aiming the locating column of the holder at the locating hole; and
pressing the installing board towards the connecting board so as to clamp the installing board between the two protrusions and the connecting board and insert the locating column into the locating hole.

8. The disassembling method of the installation equipment as claimed in claims from claim 1 to claim 6, the disassembling method comprising the following steps:
providing the installing equipment having the holder and the installing board fixed into the holder;
using the lock as the center to rotate the installing board so as to draw the installing board out of the protrusions; and
drawing out of the installing board from the lock.
